(19) United States
(12) Patent Application Publication
(10) Pub. No.: US 2004/0148476 A1
(43) Pub. Date: Jul. 29, 2004

(54) Performance-predicated automatic defragmentation of hard disks, particularly for non-pc mobile digital devices including music recorder/players

(76) Inventor: William Christopher Altare, Oceanside, CA (US)

Correspondence Address: FUESS & DAVIDENAS, Suite II-G, 10951 Sorrento Valley Road, San Diego, CA, 92121-1613, US

(21) Appl. No.: 10/205,190

(22) Filed: Jan. 28, 2003

(51) Int. Cl. G06F 12/12; G06F 12/00

(52) U.S. Cl. 711/159; 711/165; 711/112

(57) ABSTRACT

Fragmentation of files upon a hard disk drive may be avoided or mitigated by (i) writing any and all new files onto the hard disk drive starting at a location which is then, at the time of the writing of each file, at the beginning of a commodious open and terminal area of variable size at the “top” of the hard disk called the then “free space”, and then, with the free space of the disk having become filled to a predetermined extent, (ii) moving all recorded files into tight-packed sequence, using thus any disk space vacated by erasure(s) while reconstituting some portion of the “free space” and presenting all files contiguously and defragmented.

Automatic defragmentation of the hard disk drive may also, or alternatively, ensue by recognizing during normal use of the hard disk drive, and without any manual or any scheduled invocation of any fragmentation assessment routine, when the files of a hard disk drive are undesirably fragmented; and, responsively to the recognizing, defragmenting the files of the hard disk drive. The recognizing may be (i) direct, by reading of files attendant upon each start-up of the hard disk drive, and/or (ii) indirect, by assuming the files are substantially of known types, lengths and usages, e.g., digital music files, and monitoring the times and/or read faults during retrieval as an indication of the fragmented/defragmented status of the files.

### BACKGROUND OF THE INVENTION

1. Field of the Invention

The present invention generally concerns defragmentation of hard disks and hard disk drives, normally magnetically-recorded hard disks as are written in Winchester-type hard disk drives.

The present invention particularly concerns the criteria by which defragmentation of a hard disk drive may be automatically initiated, particularly for and in non-pc mobile digital devices including music recorder/players.

2. Description of the Prior Art

What is Defragmentation

The instant a file is saved on a computer hard disk, disk fragmentation begins. The more fragmented files stored in one system, the more performance deteriorates. Thankfully, the eighth wonder of the IT world, the disk defragmenter program, can almost reverse the effects of fragmentation and increase system performance significantly.

A defragmenter program is a software utility that rearranges the fragments or discontinuous parts of each file stored on a computer hard disk so that the small, empty storage spaces adjacent between fragments are substantially eliminated, effectively continuously tight packing a first region of the disk, creating enlarged remaining storage space in a second region of the disk, and possibly making file access faster.

Defragmentation is the process of (i) locating the noncontiguous fragments of data into which a computer file may be divided as it is stored on a hard disk, and (ii) rearranging the fragments and restoring them into fewer fragments or into a whole file. Additionally, successive files and/or file segments are, insofar as is possible, (iii) tight packed upon the surface of this disk, without intervening regions in which no useful information is recorded. Defragmentation generally reduces data access time, permitting magnetic disk storage to be used more efficiently in time as well as in volume. Some operating systems automatically defragment storage periodically; others require that the user occasionally use a special utility for this purpose.

The Windows™ 98 product of Microsoft, Inc., (“Windows” is a registered trademark of Microsoft) comes with a built-in defragmenter as a “system tool” that the user can run. The Windows NT product of Microsoft did not come with a defragmenter because its file system, NTFS, was designed to minimize fragmentation; however, NT users often find one necessary and several vendors provide defragmenters. The Windows 2000 product of Microsoft comes with a “light” version of the Diskeeper™ defragmenter; some users (especially corporate users) use the Diskeeper program or some other full-function defragmentation program to manage storage efficiency and performance.

Why “Defrag”?

A number of articles concerning defragmentation appear, circa 2002, on the world wide web at “searchWindowsManageability.com: The Windows Manageability Specific Search Engine presented by TechTarget.com”

In the “Case study: Defrag for less hang time”, 29 Nov. 2001, by Meredith B. Derby, it is reported that the four Windows NT servers of a Wisconsin business were crashing twice weekly and hogging CPU speed, sapping the performance of 150 work stations. Some four hours each week were spent rebooting the company servers.

Knowing operating systems can store files inefficiently, company personnel had always defragmented their computer systems but had no built-in defragmentation utility in Windows NT, nor any way to schedule defragmentations.

After collaboration on a solution for the work station problems, and research into utilities to automate and schedule maintenance, Executive Software's Diskeeper, O & O Software GmbH's Defrag 2000 Professional Edition and Gaithersburg, MD-based Raxco Software's PerfectDisk became the top three contenders.

After downloading all three products, one was set up on test machines on identical hardware, and after a week, rolled into production use on the system's heaviest users. The software was scheduled to defrag the computers each day at lunchtime. Performance of these computers was then compared to similar users who didn't have the defrag software installed.

It was found that defragmenting of the Windows master file table (MFT) was useful, the MFT when highly fragmented causing the hard drive to fail find the correct files needed to run the operating system, and crashing the computer. Importantly, the MFT can only be defragged when machines are booted up.

The selected Defrag 2000 Pro software product defragments the MFT file every time a computer is rebooted. It also can be scheduled to defrag the other files at any time. If the scheduled defrag is missed because a computer is not turned on, the software will know and will run it within 72 hours of the missed date, the system administrator receiving a report that the failure has occurred.

A cutback in help desk calls, better end-user performance and more system reliability were realized benefits, with a 17-23% increase in work station performance.

In another article “Disk defragmenting dos and don'ts” also by Meredith B. Derby it is related that, since Windows stores files in fragmented chunks, disk fragmentation is a fact of life in Windows environments. The trick is to prevent fragmentation from hindering system performance.

The system administrator of the same Wisconsin business advises:

“Do run your defrag software religiously on every work station.” At a minimum, run it at least every 30 days.

Do run it on your most heavily used computers at least every two weeks. This will increase their computer's performance, causing them to track you down less.

On the server side, do schedule it to defrag during inactive periods, such as late at night. And do run those at least once a week.

Don't forget to shut down any running applications. Files in use when the software runs will not be defragged.

Do set up a test environment to get a feel for which “defragger” will work best. “Compare apples to apples, Even if you think different products are incredibly similar, it is still worth your time to compare them.”

Do test them on similar hardware with similar configurations, he said. This will allow your tests to be as accurate as possible.

Do look at all the features that might benefit you. Look at the functionalities offered, the reliability, and how easy the monitoring will be.

In yet another related article the “Top 10 disk defragging pointers” again by Meredith B. Derby, the best ways to harness the power of a defragmenter are related by Frank Alperstadt, managing director of Berlin, Germany-based O & O Software, GmbH, maker of two Windows defragging products.

Alperstadt finds that the biggest mistake an IT manager can make is not to use defragmentation software. Defragmentation can result in a 200% performance gain on a single computer. Leaving your hard disk fragmented is simply another way to burn money. Total cost of ownership may be reduced dramatically simply by installing (and using) a defragger.

He finds an important part of defragmenting is knowing when you need to run the software. Disk fragmentation causes a bad slowdown of your system. Defragmentation itself usually costs resources, too. It is up to the user to see when he/she will need to defrag his/her hard disk. If you think you need to, remember that it can be a very time consuming process. Some defraggers, however, have an integrated functionality to check automatically if your hard disk is fragmented more or less than a predefined value.

Disk fragmentation starts even if there are only two files on your disk and only one file has been changed. You should start defragmentation right after the installation of the operating system and, of course, after installing your defragmenter.

Know your disk capacity and potential disk errors.

The biggest hurdle defragmentation software encounters is heavily loaded hard disks. There must be a minimum of 15% free disk space to start the defragmentation.

Broken hard disks (e.g. hard disks containing bad sectors) shouldn't be defragmented. So, check your disks for errors before defragmenting.

Alperstadt finds the most critical aspect in defragmenting a server is the availability of the server. The defragmenter should not use all the resources for the defragmentation. It should leave enough free memory and processor time so the server can fulfill its main tasks while being defragmented. If the server is not defragmented periodically, it can be a time consuming process because there are large amounts of files being stored on them.

Running defragmentation software, like running any other software on a computer, costs performance time. So if it is desired to defragment hard disks, leaving the computer alone for a while (maybe a long while), and letting the defragger do its job, is recommended. Some defrag tools address this issue. They have an integrated technology that listens to the system and stops the defragmentation if the user works with the machine. If the user pauses, the defrag process continues automatically.

Defragmentation usually doesn't conflict with other applications. If the defragger finds a file locked by another application, this file will not be touched. However, newer defraggers write these files to a database and defragment them during the next boot process.

If you compare a file server with a database server, you will find many differences. The defragmentation software should respect these differences. On file servers, the software should not only defragment files, it should reorder them by the date of last file access. So a computer owner/user can thus save time, and therefore money, if it is needed to search for a file later.

Although the various computer defragmentation schemes and software not strictly relevant to the present invention save to show that there are all types and qualities of defragmentation, Alperstadt advises not to rely on the built-in Windows defragger. In Windows 2000/XP built-in software calls itself a defragger. This tool is slow, incomplete and has a limited scheduling capability. Further, it can only defrag one drive volume on a machine at a time.

In summary Aperstadt finds that it is absolutely necessary for administrators of large enterprise networks to be the only ones who manage the defragmentation of their work stations and servers. They should ask themselves: Can work station users defragment themselves? Keep in mind that most users don't have administrator rights on their machines.

In still yet another article “Case study: Ending the remote defrag drag” by Jan Stafford, 20 Feb. 2002, at the searchWindowsManageability.com site, Momentum HealthWare Information Systems IT manager Paul Beaudry finds that the attitude “If it's not broken, don't fix it” could be the slogan for many businesses' IT shops, said. With that attitude, he would have simply zipped past an ad for a disk defragmentation tool that could improve his system's performance. After all, his existing defrag tool wasn't broken.

“It's easy to get complacent, stick with the vendor you know and not keep your eyes and ears open,” said Beaudry. Often, this approach results in so-so performance and higher total cost of ownership in systems worth tens of thousands of dollars. Making poor use of large system investments is not acceptable for Beaudry. “If I see a way to get a percentage point improvement in my system, I'm going to go for it,” he said.

The fact that MHIS has many remote workers poses a tough management problem for an efficiency-focused IT manager. The Winnipeg, Manitoba, Canada-based MHIS creates financial, clinical, client and dietary Information software for the health care industry. Working as salespeople or implementation specialists, MHIS employees travel with laptops running Microsoft Windows NT or Windows 2000 and Microsoft's SQL Server database. Disk fragmentation is a common occurrence in Windows-based computers. As fragmented files pile up in one system, performance deteriorates.

“Unless you can centrally manage PCs, you don't know if they're being defragged regularly,” said Beaudry. Defragging may not be taking place for various reasons, ranging from lack of disk space to the power being off for long periods to software errors.

Unfortunately, MHIS' legacy defrag tool—Diskeeper from Burbank, California-based Executive Software—requires that each “disk be managed individually.” Beaudry couldn't keep tabs on laptops that remained out of the main office for weeks at a time. Users would return after long absences and complain that their laptops were running slowly. Often, the cause was disk fragmentation.

With this problem in mind, Beaudry was drawn to an ad for Defrag Commander. The ad said the tool could be managed from one computer. Also, Defrag Commander—created by Austin, Tex.-based Winternals Software—doesn't require manual installations on desktops.

Intrigued, Beaudry ordered a demo copy and ran a test on a Windows 2000-based server. He found that Defrag Commander defragged quickly in a single-pass. Also, it offered daily reports detailing activities on each computer on the defrag schedule.

With Defrag Commander, defrags run on a schedule set the IT manager. “If someone's machine isn't on when the defrag is scheduled, the defrag happens automatically when they power up again,” Beaudry said. Less user support is needed, because users aren't involved in the process. In fact, they don't necessarily even need to know about it.

“We ran trials on machines that had Diskeeper installed,” said Beaudry. “In all cases, we were able to defrag beyond what Diskeeper could do.” Also, he added, “Diskeeper is significantly more expensive.” In fact, he couldn't find any other add-ons that, for the same money, could match Defrag Commander's performance.

Rather than scrapping Diskeeper, Beaudry decided to use Defrag Commander as a complementary solution and for upgrades. The initial investment of $1,100 gave him central management capabilities for over 150 desktops.

Beaudry installed Defrag Commander on a Windows 2000 server in November 2001.“It's running so smoothly I can practically forget about it,” he said. “From an IT management and TCO perspective, it doesn't get any better than this.”

The Nature of Digital Audio Files

Extraction, or “RIPPING” of audio from a CD? is explained in the article “About Digital Audio Extraction” by Bob Starrett a=on the world side web circa 2002 aT <http://www.cdpage.com>.

Accurately copying a Red Book (audio) track from an audio compact disc to hard disk or another CD is a continuing challenge, but it has recently become less difficult due to advances in hardware and software technology.

Audio tracks are not like regular computer data files; they are made up made up of data that is meant to stream, and this stream contains more than music. The stream itself is not simple; it is interleaved, meaning that portions of a song that naturally follow each other when playing the song do not follow each other in the physical layout of the disc itself. This is part of the disc's error correction, used to ensure that errors (caused by dust and scratches, for example) do not cause audible errors when the disc is played.

Digital Audio Extraction, or DAE, is sometimes, perhaps unfortunately, called “ripping”. Ripping involves moving the contents of an audio track on a CD to a hard drive or other storage device, by reading the track from the CD and creating a file that can then be manipulated in various ways. A number of file formats can be used, including AIFF on the Macintosh and the WAV format under Windows.

Why is it sometimes difficult to get good-quality audio extracted from a disc? And why is the process so slow in many cases? This takes a little understanding of how the data on an audio disc is organized.

An audio disc consists of frames, each of which contains 24 bytes of user data, synchronization, error correction, and control and display bits. The audio CD's data is not arranged on the disc in distinct physical units. The data in one frame is interleaved with the data in other frames. This prevents a scratch or other defect in or on the disc from destroying a frame beyond the ability of the reader to correct the data. A scratch will destroy a little bit of many frames, rather than a whole frame or frames, so, using error correction technologies, the missing data can be recovered and the disc can play normally without discernible loss of content or quality.

Use these tips when ripping audio and your chances for success will increase:

1. Make sure the disc is clean, free of dust, fingerprints and other foreign matter. Discs can be cleaned with commercially available cleaners and cleaning kits, but these are not necessary to ensure a clean, readable disc. Simply hold the disc under warm, running water. Lather one hand with hand soap (bar or liquid), and rub the soap gently on both sides of the disc with your fingers. Rise your hands and the disc well with warm water and pat the disc dry with a soft, lint-free cloth or towel.

2. Make sure the disc does not suffer from any of the following conditions: warping, deep scratches, or a nicked or peeling reflective surface. These can cause the reading drive to seek excessively as it tries to read damaged or unreadable errors, resulting in long ripping times or corrupted files.

3. Use your best drive for ripping, even if it is not your fastest drive. If you have more than one CD recorder or CD-ROM drive, try your fastest drive first. If the results are not satisfactory (you can tell by listening to the ripped file!, use a slower drive.

“Best drive” is, of course, a subjective judgment that you will need to make for yourself after some experimentation. You can usually depend on drives from well-known manufacturers to do a good job at audio extraction. On the other hand, some models from major manufacturers have been known to do extraction poorly or not at all. Many inexpensive, non-branded drives rip audio just fine. Newer drives will perform better than older drives, not just because they are newer, but because many of them incorporate new technology that makes ripping faster and more accurate. While many older CD-ROM drives will work for extracting audio, they were not built or optimized for that task, and extraction software will have to work longer and harder to get the audio track from the disc into a clean file for recording to CD-R.

If possible, dedicate a hard disk drive to ripped files, perhaps an older, smaller hard drive that you have lying around. This prevents hard disk phenomena (such as cross-linked files and excessive fragmentation) from causing problems when you re-record the files to CD. If you use a separate drive, you should have to defragment it less frequently, as all the files on it will be large files. An added bonus is that, instead of defragmenting the drive, you can just format it after you have made your CD and be assured of clean contiguous disc space for your next extraction job. (Recall that full defragmentation of a large hard drive takes quite a bit of time, and ties up your computer until it's done.) Get a good CD-ROM drive for audio extraction. How do you know which ones are good? The Adaptec CD-R discussion list is a good place to find out the opinions of many other CD-R users; the question has been discussed extensively in the list in the past, and is frequently re-discussed as new models are released. To see what's been said most recently, have a look at the list archives at http://listserv.adaptec.com. You can also join the list yourself and ask; see http://www.cdrcentral.com/community/policies.html for more information.

To understand why audio ripping can be so unpredictable, we need to look at the structure and function of audio discs as opposed to data discs. Copying files from a data disc to hard disk is easy and reliable. This is not always the case with audio tracks. An audio (Red Book) disc is divided into three distinct areas: the Lead In, the Program Area, and the Lead Out. The location, or address, of each audio track on a disc is stored in the disc's Table of Contents (TOC) in the Lead In area of the disc.

The TOC of an audio disc, much like a book's, is a good source for finding out what is where on the disc, but it cannot always lead you to the right place in the book. Let's say we have a chapter in a book that is entitled “How to Record an Audio CD”. If we want to learn about ripping, the TOC will tell us that this chapter begins on page 123, but it does not tell us where within the chapter the part about ripping begins. The Table of Contents on an audio CD tells the CD-ROM drive approximately where a song begins on the disc, but, unlike a data CD-ROM, it doesn't tell the drive exactly where it starts.

Since audio discs were designed to be played sequentially in real time, it was not thought necessary to have information on the disc that pinpointed the exact location of the beginning of a track; it was good enough to get close to the location. To have that extra data with an exact starting address for every track would have taken up space on the disc that could otherwise be used for music.

The sectors on a data CD, on the other hand, has only 2,048 bytes of user data in each 2,352-byte CD-ROM sector. These sectors can be accessed exactly because the header information (the remaining 304 bytes) in each sector holds the precise address of the data block.

An audio block also contains 2,352 bytes, but all of these bytes are used for audio. There is no header, so there is no information within the block to allow for the exact positioning of a drive's read head over a particular block. To locate a specific audio block, a CD drive must take advantage of the Q subcode, but this allows head positioning only to within 1 second of the true block address. When seeking an audio block, a CD-ROM drive only moves the read head to a position close to the requested block, and then it compares the Q subcode to the block address being sought. The Q subcode references the minute, second, and frames relative to the start of the track and also the Absolute Time (that is, the time in minutes, seconds, and frames relative to the whole disc).

When a drive is asked to seek to an audio sector, it begins reading, then compares the Q subcode information to the block address it is looking for. Data transfer begins when the drive has located a Q subcode address close to the requested block address. Many CD-ROM drives seek an audio address within four Q subcode addresses of the address being sought (4/75th of a second in playback time). In this scenario, a request for a particular audio block could return any of nine blocks close to the desired position. This is why extraction is not exact. Clicks and pops that you sometimes hear in ripped files can be caused by this inexact positioning.

Recently, some advances in extraction technology have made ripping much less troublesome, and completely error-free in many cases. The ATAPI (SFF8020) specification includes the new MMC command set and is now used by many drive manufacturers in current lines of CD-ROM drives. The Multimedia Command Set (MMC) has this advantage: many of the commands that were previously performed in software can now be executed by the CD-ROM's controller chip. One of these functions is the real-time error correction of Layer 3 Reed-Solomon Product-like Code (RSPC). Others are error detection, real-time ECC correction of one byte per P-word and Q-word, and repeated ECC passes. Repeated ECC passes increase the reliability of the drive's read function. Controllers from Oak Technology and Winbond, the most widely used CD-ROM drive controller chips, have these functions built-in. Accordingly, recorders and drives with these chips can extract audio more effectively and efficiently; less complicated algorithms can be used by the ripping software. As these controller chips position the read head more accurately than before, existing synchronized read algorithms will also work faster. This is because data comparisons will match sooner and the head can then move to the next portion of data quickly. This new feature is called “Accurate Streaming”. Drives using Accurate Streaming can rip in a burst mode. Thus, extraction speeds are faster and the extraction is much more accurate.

### SUMMARY OF THE INVENTION

The present invention first contemplates performing the defragmentation of a magnetic hard disk, and of a Winchester-type magnetic hard disk drive, automatically conditioned upon assessment of any of (i) the fragmentation status of the disk, (ii) access performance to records upon the disk during use, and/or (iii) exhaustion of available disk recording space, this assessment of the remaining disk recording space being especially relevant where the disk's recording space has been consumed by a novel procedure where newly added files are added to the disk sequentially from disk beginning to disk end. In simplest terms, the present invention accords for recognizing that a Winchester-type magnetic hard disk drive needs defragmentation as may be determined by any one or ones of a number of (i) drive status and/or (ii) performance indices.

The present invention further, second, contemplates a strategy and a method for reducing the fragmentation of records written upon a Winchester-type magnetic hard disk drive in the first place. The method has, however, a requirement—in the nature of a trade-off—that an accompanying “defragmentation-type” operation—generally shorter, simpler and faster than what is normally considered a defragmentation—should be often performed, especially for disk drives that become substantially full.

1. The Particular Consequences of Hard Disk Drive Fragmentation for Portable Digital Music Recorder/Players

The present invention is of particular utility in non-personal-computer type portable digital devices having read/writable magnetic disks such as, among other similar devices, portable recorders and players of digital music (of any format). These devices are prone, as are all disk drives, to becoming fragmented during the reading and writing of files. Reasonable patterns of usage of music player/recorders can make that such fragmentation accrues as, at the least, (1) negatively affects power consumption as the mechanical read head of the disk must be frequently repositioned during the retrieval (or writing) of a single file, or, at the worse, (2) prevents uninterrupted playback and/or (3) precludes error-less recording.

Nonetheless to this occurrence—inevitable with the installing and un-installing of many files (i.e., song tracks) over time—digital recorder/players are being sold circa 2002 that do not even have a defragmentation capability. It will thus likely be a surprise to the owner/users of these units that, at least after some years of use during which some interchange of the contents recorded on the disk occurs, performance may become so degraded that (i) new tracks (files) cannot be accurately recorded at all, (ii) fragmented old tracks (files) cannot be read without discernable defects in the audio playback, and/or (iii) overall storage capacity diminishes as a function of the accrued fragmentation of the disk. Of course, should (i) the recording/playback device have a computer interface and its owner/user have (ii) a computer (iii) accommodating this interface also with (iv) adequate storage capacity, it may be possible to off-load the disk of the device to the computer, and to then re-write contents (i.e., files) onto the disk substantially sequentially, and with reduced fragmentation. However, in other cases it may come as a rude surprise to the owner/users of digital music recorder/players to note that their multi-year accumulation of music tracks has become moribund due to fragmentation problems with the hard drive of the recorder/player.

2. Eliminating Hard Disk Drive Fragmentation in the First Instance

The second aspect of the present invention—the strategy for reducing the fragmentation of records written upon magnetic hard disk drives in the first place—is now first discussed because, if disk fragmentation can be avoided or minimized in the first place, then the importance of defragmentation, automatic or not, is diminished. However, the elegance, sophistication and innovation in both recognizing any need for defragmentation, and in automatically performing defragmentation, as is accorded by first aspect of the present invention will be seen to be complimentary of use with this second aspect of the present invention. In fact, and as will be explained, both aspects have their own merit, and applicability.

Fragmentation avoidance in accordance with the present invention is embodied in a special method of managing the digital recording of files on the hard disk drives of, most typically, generally-portable digital-recording-and-playback devices, most commonly as are used for digital music. These devices most typically have only modest amounts of (1a) high-speed semiconductor memory, if not also only modest (2a) instruction set architectures and/or (3a) logical performance capabilities, relative to the (1b) memory capacities, (2b) instruction sets, and/or (3b) computational performance of computers. The special method is based on the recognition of several differences between, on the one hand, (1) computers and their typical uses and, on the other hand, (2) digital music recorder/playback devices and their typical uses.

First, (1) computers often retrieve a program from a hard disk drive to semiconductor memory and commence to use it for a time that is relatively long, with but modest further disk references, relative to (2) a digital music player, which is essentially but a reading, writing and interpretation unit for encoded records digitally written upon the hard disk drive.

Second, any (1) buffer to the hard disk drive itself, plus (2) such buffer to the hard disk drive that is innately accorded by the relatively high-speed semiconductor memory of a computer, plus, to a much lesser importance, (3) a possible cache memory (of even higher speed) to the computer microprocessor itself, all serve to make that a computer is more unlikely to be negatively impacted by modest levels of hard disk fragmentation than is a simple recorder/player of digital music, or the like.

Of course, one way to attack the disk fragmentation problem within a digital recorder/player is to put a commodious semiconductor memory buffer within the recorder/player in order to substantially eliminate—if not the frequent and power-consuming seeks by the head of the magnetic disk—the substantial possibility of breaks in the data stream upon reading or writing due to excessive fragmentation of the read files. This is, however, the wrong way to go: (1) simply delaying the inevitable as fragmentation gets worse and worse, (2) increasing cost, and (3) failing to accord for such higher recording and reading rates as may in the future attend, by way of example, digital video. A better approach is to keep the disk drive adequately defragmented.

Third, a computer typically has, with its typically larger high-speed semiconductor memory and its more extensive digital logics, a better and more powerful capability to defragment a hard disk drive than does a much, much less expensive recorder/player. In other words, although aficionados of digital music recorded in, for example, the MP3 format may keep their music tracks (files) on both their thousand-dollar level personal computers and also on their hundred-dollar level portable recorder/players, the computer has much more “horsepower” to defragment a disk drive when and as proves necessary or prudent.

According to all these considerations, it is relatively more desirable to prevent the hard drive of a portable digital recorder/player device from becoming fragmented, let alone badly fragmented, in the first place than it is, by way of comparison, to prevent the hard drive of a personal computer from becoming equally as fragmented.

In accordance with the second aspect of the present invention, fragmentation is completely avoided upon the initial writing of digital records, particularly digital music, by the simple expedient—implemented in the logical design of the hard disk drive recording control (micro) program—of writing new files into, and starting at the then beginning of, a (generally, relatively) commodious open and terminal area of the hard disk called “free space”. The hard disk drive file writing control is set to permit new files to be written into this free space only. As the free space fills and as previously written files are erased, then the hard disk drive—even though erased files and their attendant voids have become present—is still technically non-fragmented. It is also, of course, replete with such voids between records as make usage of the full storage capacity of the hard disk is at least temporarily inefficient, and sub-optimal.

In accordance with this second aspect of the present invention, upon the completion of filling the defined free space to some predetermined extent, a message will preferably be sent, either audible or visual, to the device's user demanding or petitioning that compaction of the hard disk drive should proceed. Although such compaction is but a simple, and degenerate, form of general defragmentation, there is little use of confusing the user with this minor distinction nor, for that matter, presenting him or her with the need to make a decision. Accordingly, the preferred form of the user notice is a visual message similar to the following: “Automatic Defragmentation will start in [a predetermined period of time; as is predetermined and displayed to the user]; no file recording can proceed until finished.”

The automatic simplified defragmentation, as is most commonly implemented in firmware, will then start moving complete files upon the hard disk drive into a continuous, tight-packed, sequence commencing with space previously occupied by the now-erased file closest to the beginning of the hard disk drive. The simplified defragmentation operation will complete upon the “down” relocation of all stored files. A new free space at the “top” of the disk drive will then be registered to the control (micro)program, and available for use. By this procedure fragmentation of old or new files is not possible because all files are written linearly into the “free space” of the hard disk drive only.

3. Automatic Defragmentation of a Hard Disk Drive

In its primary aspect the present invention is embodied in an automatic defragmentation method. The “automatic” of the method is more for the recognition of when a hard disk drive—particularly as may be used in a generally-portable digital-recording-and-playback device most commonly as is used for music—needs defragmenting than for the manner of actually conducting the defragmentation of files, which is substantially conventional.

In accordance with the present invention, fragmentation of a hard disk drive is automatically detected either (i) directly, by reading the records (files) stored upon the hard drive and assessing the extent of their fragmentation, and/or (ii) indirectly, by assessing read/write performance of the hard drive in a manner that is unique, and un-associated with computers.

When fragmentation is detected (i) directly, then either a factory fragmentation level is preset, or a user-definable fragmentation level is set, and thereafter fragmentation is automatically checked upon each start up of the mobile or non computer hard disk drive device. If the fragmentation level is detected to be under the factory or user definable preset/set, then the further automatic defragmentation function is by-passed. If the fragmentation level is at or above factory or user definable preset/set, then the further automatic defragmentation function is activated.

The automatic defragmentation preferably proceeds by first checking the power levels to ensure defragmentation can be accomplished without power loss. Next an alert audible or visual or both is sent to the user stating automatic defragmentation is required and will start in a variable preset amount of time, permitting the user to disable this function if he chooses not to proceed. Upon automatic start-up or user manual initiation of defragmentation, all operational functions of the non-computer hard disk drive device will normally be locked out, and disabled, for the duration of the defragmentation operation. Sometimes, however, certain or all of the operational functions of the device are non-conflicting with (certain, normal) defragmentation processes, and may be permitted to transpire in even time with the defragmentation. In this case the “automatic defragmentation” or, more properly, the file defragmentation portion thereof, is said to transpire “transparently in the background”. The permitted operational functions always exclude powering off, or shutting down, the hard disk drive.

As is substantially conventional in a hard disk drive file defragmentation process, the hard disk drive is first analyzed by the auto-defragmentation program which is, for the instance of a portable digital device, commonly implemented in firmware. Defragmentation of the hard disk drive then occurs; protecting the file allocation tables (FATs) and file structures while realigning the segments and clusters to eliminate fragmentation of the files.

After completion of the auto-defrag function, a reanalysis of the hard disk drive preferably occurs automatically. Status is preferably displayed to the user as either “complete” or “finished” or the like and, preferably, the newly-adjusted free space capacity of the hard disk drive—especially if changed because of the defragmentation—is preferably displayed.

Further in accordance with the present invention, it is alternatively possible to (ii) indirectly assess the fragmentation level of a hard disk drive by assessing the read/write performance of the hard disk drive. This assessment depends upon having a general, if not also a specific (derived from the file allocation tables), knowledge of the (i) size and (ii) nature of the files that are stored in the digital device, and the (iii) normal manner of their use. The assessment is thus not suitable to a computer, where files of many different lengths, types and uses are stored on the computer's hard disk drive.

However, a straightforward, and important, example of where such an assessment may usefully be made concerns the digital music files—whether in a WAV or MP3 or other format—of a digital music recorder/player device. Many of these files will exceed a certain size, as is characteristic of a song or other musical work. The substantial number of files may be assumed to contain digital music. Finally, one normal manner of the use of these files is to read then out from beginning to end, as permits the playing of music.

The (micro)program that causes the reading of digital data from the disk can, by reference to a watchdog timer or the like, or to an interrupt attendant upon a buffer underflow of the like, that there has been an interruption in the retrieval of the digital data, and in the playing of what is presumed to be music. An occurrence of this for one, or some few, times may not be conclusive of anything. However, an up-down “pseudo fault” counter may be kept, and/or like programming techniques employed, to determine both (i) whether things are changing (i.e., getting worse) over time, and/or (ii) whether defragmentation—which may be at times and from time to time user initiated—has any affect on the occurrence of apparent “faults”. If (i) the user seems to like to manually initiate defragmentation of the hard disk drive—putatively for cause—and (ii) some change of some moment can be detected in the “fault” counter, then the firmware program can act to thereafter alert the user to a detected accrual, or escalation, in detected “faults”, and ask the user to approve an automatic defragmentation of files.

This alternative method does not always work to detect a single, or some few, highly fragmented files. This method may take some time—dependent upon the types and lengths of files being processed, the user attentiveness to the audio output and his/her action (if any) dependent upon any detected faults in this output, and/or the effectiveness of the (micro)program to recognize that an untoward condition is (re)occurring—to stabilize, and to contribute to the conduct of defragmentation when, and only when, both propitious and timely. However, this alternative method does have the advantage of working in a hard disk drive device that is never shut off, and/or is shut off infrequently relative to its accrual of unacceptable fragmentation levels.

It is possible to use both methods at once, both directly and indirectly assessing the need for defragmenting the hard disk drive.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a schematic diagram of an exemplary digital hard disk drive device, to wit: a portable combination CD-ROM and MP3 recorder-player, in which any of the automatic defragmentation methods of the present invention are operative.

FIG. 2 is a flow chart of a preferred embodiment of a first automatic defragmentation method in accordance with the present invention.

FIG. 3 is a flow chart of a preferred embodiment of a first automatic defragmentation method in accordance with the present invention.

FIG. 4 is a flow chart of a less preferred embodiment of only a defragmentation operation as may be performed as part of the automatic defragmentation of the present invention.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

1. An Exemplary Digital Hard Disk Drive Device on Which any of the Automatic Defragmentation Methods of the Present Invention are Operative

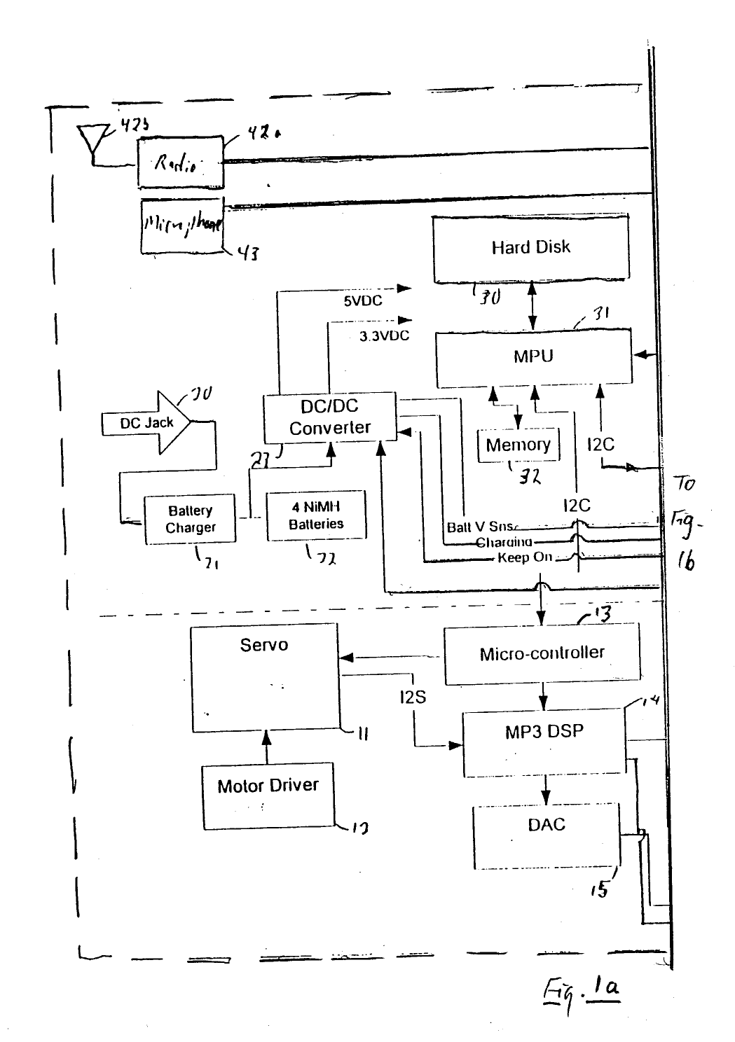

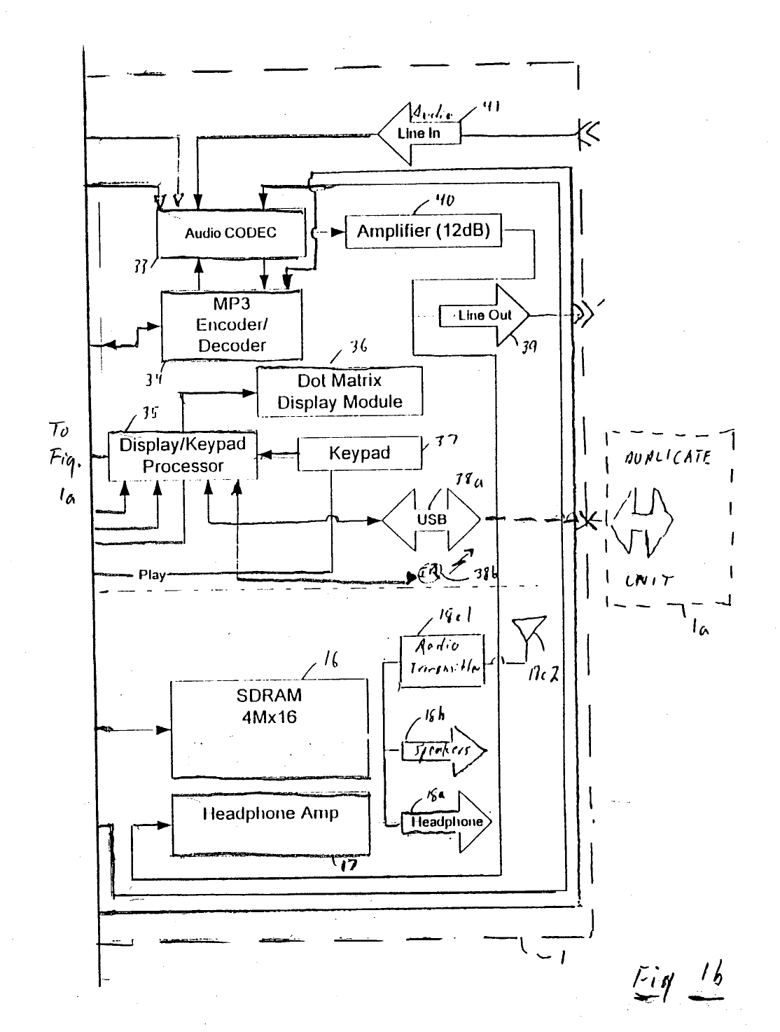

A schematic diagram of an exemplary digital hard disk drive device—to wit: a portable combination CD-ROM and MP3 recorder-player—in which any of the automatic defragmentation methods of the present invention are operative is shown in the schematic diagram of FIG. 1.

This entire section 1 is substantially only to show, and explain, that in a disk-based digital recorder/player, digital records—digitalized music files—are at times, and from time to time, recorded to and read from the hard disk drive. Moreover, in doing so, the records, or files, become fragmented. Readers who find this simply concept completely clear and blatantly obvious may usefully skip to the next section 2. Other readers who want to know exactly how, under programmed control, digital data encoding music (sound) may be moved to and from a hard disk drive for purposes of writing (recording) and for reading (playing) may usefully read this section 1.

The device of FIG. 1 is the subject of the inventor's co-pending U.S. patent application Ser. No. 09/860,935 filed May 18, 2001, for a PORTABLE CD-ROM/ISO TO HDD/MP3 RECORDER WITH SIMULTANEOUS CD-READ/MP3 -ENCODE/HDD-WRITE, OR HDD-READ/MP3 -DECODE, TO PLAY, POWER-SAVING BUFFER, AND ENHANCED SOUND OUTPUT. That application is itself descended from, and claims benefit of priority of, U.S. provisional patent application Serial No. 60/205,936 filed on May 18, 2000 for an ECHO MUSIC SYSTEM. This particular device, and its salient characteristics, are in no way required for the practice of any and all of the methods of the present invention. The device of FIG. 1 simply represents one, exemplary, platform upon which the methods of the present invention may usefully be implemented.

For the sake of completeness, the explanation of the device as explained in the companion predecessor application is as follows:

The device of FIG. 1 supports as its principle function the playing and recording of digitally encoded music. More particularly, it conventionally performs a sequence of 1) first-converting at a first time successive first-bit-length first-encoded first digital words to a first analog signal; 2) first playing at the first time this first analog signal through speakers or headphones or the like to the human ear, while also 3) second-encoding and re-digitizing, preferably at the first time, this first analog signal into a successive second-bit-length second-encoded second digital words, followed by 4) storing these second digital words until, at a later second time, 5) second-converting the second digital words into a second analog signal, and 6) second playing also at the second time this second analog signal through speakers or headphones or the like to the human ear, or the like.

In this substantially conventional sequence the device of related application realizes, inter alia, (1) (re-)encoding an audio wave form (for later playback) in a longer code word, and better encoding format, than that word and format in which the audio wave form was initially encoded; (2) conserving power in a portable CD-ROM and MP3 player-recorder by various strategies of (2a) minimizing data references to a hard disk drive (HDD) by use of a large data buffer, (2b) eliminating any reference to the HDD for instructions, and (2c) eliminating any microprocessor (in performance of MP3 encoding/decoding); (3) simultaneously reading cd-rom while encoding MP3 and writing a HDD, or reading the HDD and decoding MP3; (4) the retrospective selection of songs for recording; and (5) computerless high-speed transfer between MP3 player-recorders, commonly called a “bulk dump”.

The elements of the recorder-player device shown in the schematic diagram of FIG. 1 appearing below the horizontal dashed line are substantially pre-existing and conventional. The elements of the invention that is the subject of the related invention are substantially shown above the horizontal dashed line—although the nature and function of these particular elements is in no way required for operation of the present invention.

Referring to FIG. 1, below the horizontal dashed line a Motor Driver 12, preferably type MM1538 or FAN8038, powers rotation of a CD-ROM (not shown) so that a Servo 11, preferably type CXA2550, CXD3068 OPU(KSM900), under control of a Micro-controller 13, will deliver, during rotation of the CD/ROM digital data in the form of ISO CD/ROM code words to the digital signal processor MP3 DSP 14, preferably type RSM88131A or TR2101. The entire CD mechanism may be, for example, Sanyo type DA23.

The digital data from the CD/ROM is buffered in a memory SD RAM 16, preferably of size 4M words of 16 bits each (NOTE: this buffer memory should not be confused with the buffer Memory 32). Decoded digital data—representing an audio wave form—from the MP3 DSP goes to audio digital-to-analog converter DAC 15, preferably type WM8725 or AK4352, and also to MP3 Encoder/Decoder 34 which is a new chip type YMPC-3001 from Yountel of Korea.

Meanwhile, an audio signal from the DAC 15 goes to audio companding de-companding circuit Audio CODEC 33, preferably type UDA1342TS from Philips.

The elements added to this base structure of a CD/ROM reader in order to realize the combination CD/ROM and MP3 recorder-player are now introduced in the context of an exemplary function that, at various times and under various user/operator control, is performed by these element. One function, and operational mode, of the combination CD/ROM and MP3 recorder-player is called “play, and record from analog”. In this operational mode, and for this function, an audio signal from the DAC 15 received in Audio CODEC 33 is directly routed to Amplifier 40 of nominal 12 db gain, and then to Headphone Amp 17, and then for play to any of (i) Headphone 18a, and/or (ii) Speaker 18c1, and/or (iii) through Radio Transmitter 18d1 and antenna 18d2 via a low power radio signal (preferably FM) to a proximate radio (not shown) for reception and play through the sound output system of the radio. Meanwhile this audio signal is also passed through the Audio CODEC 33 to the MP3 Encoder/Decoder 34 where it is encoded to MP3 code, preferably at a 24 bit code word bit length.

The MP3 encoded data is passed though the file management unit MPU 31—a custom chip for which may be substituted for purposes of the present invention a microprocessor—first to the buffer Memory 32, which is preferably of the FLASH or DRAM types. When the buffer Memory 32, which is preferably 64K or larger in size, becomes filled, then its contents (such as are then selected for permanent recording) are moved en masse through and by the MPU 31 to the Hard Disk 30, which is preferably of the Winchester type, and is more preferably a magnetic disk of 10 Gbyte or greater capacity.

At the conclusion of the “play, and record from analog” operation, the audio CD/ROM has been played, and MP3 encoded data in respect of the contents thereof the CD/ROM lodged on the Hard Disk 30.

Another, similar, function, and operational mode, of the combination CD/ROM and MP3 recorder-player is called “play, and record from digital”. In this operation mode a digital signal (reflective of an analog audio wave form) from the MP3 DSP 14 bypasses Audio CODEC 33 and is sent to MP3 Encoder/Decoder 34. The decoding of this signal to analog audio is sent to the Audio CODEC 33 and then to the Amplifier 40 and so on, meaning to the Headphone Amp 17, and then for play to any of (i) Headphone 18a, and/or (ii) Speaker 18c1, and/or (iii) through Radio Transmitter 18d1 and antenna 18d2 via a low power radio signal (preferably FM) to a proximate radio (not shown) for reception and play through the sound output system of the radio.

Meanwhile the MP3 encoded data from the MP3 Encoder/Decoder is sent to the MPU 31 where it essentially undergoes the same treatment as it was previously. Namely, it is passed first to the buffer Memory 32 and then, when the buffer Memory 32 becomes filled, the MP3 data is moved en masse through and by the MPU 31 to the Hard Disk 30, where it is stored.

Accordingly, at the conclusion of the “play, and record from digital” operation, the audio CD/ROM has again been played, and MP3 encoded data in respect of the contents thereof the CD/ROM has again become lodged on the Hard Disk 30.

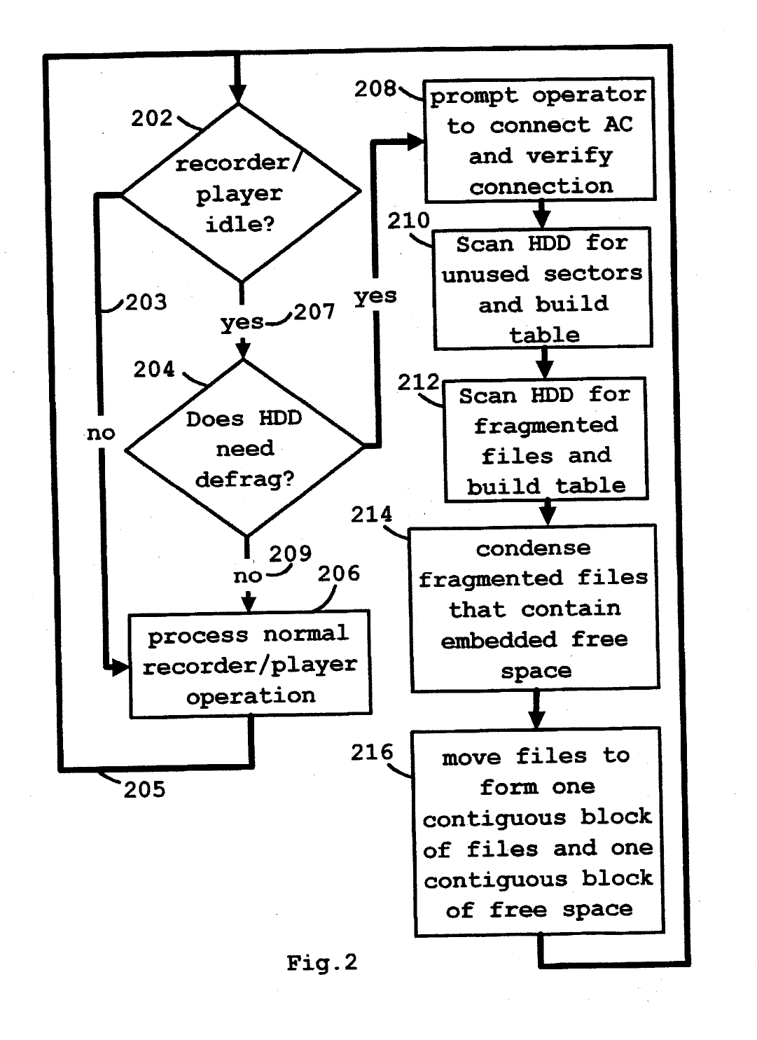

Both the “play, and record from analog” operational mode illustrated in FIG. 2a, and, more preferably, the “play, and record from digital” operational mode illustrated in FIG. 2b can be replicated in a “Program” mode where (i) audio play is disabled and, as a consequence that the information ultimately retrieved from the CD/ROM need not be played in real time, (ii) the entire process of MP3 encoding and storage may be run faster, essentially as fast as the weakest link in the chain of reads, decodes and/or conversions, and writes will run. Normally the weakest link is the CD/ROM, which is then spun at 4× to 6× normal speed. Because of settling time in the de-companding circuits of the CODEC 33, it is preferred that the MP3 encoded data be developed in and by the “record from digital” operational mode.

The entire purpose of logging MP3 data to the Hard Disk 30 has been, or course, to provide for later retrieval and play. In an operational mode, and function, to “playback MP3 from hard disk” operational mode of the player-recorder. During playback the MP3 data from the Hard Disk 30 is extracted to, through, and by the MPU 31 to the buffer Memory 32. The MPU 31 also serves to issue successive MP3-encoded data words to the MP3 Encoder/Decoder 34 now acting as an MP3 decoder. The MP3 data decoded to a companded and encoded audio signal is sent to the Audio CODEC 33 where it is de-companded and further decoded to produce the pure audio signal sent to the Amplifier 40. As is by now understood, the path of the audio signal from the Amplifier 40 ultimately permits that it is transduced to sound in, by way of example, Headphone 18a.

The portable combination CD/ROM and MP3 recorder-player of FIG. 1 may transfer MP3 data to a like unit—normally over a code-word or otherwise protected proprietary transfer-level-protocol-protected interface—to an identical, or like, unit. MP3 data from the Hard Disk 30 is transferred by action of MPU 31 to be buffered in buffer Memory 32 and then, as called for by Display/Keyboard Processor 35—which manages the Universal Serial Bus 38a, or the Infrared Transceiver 38b for purposes of data transfer to the other device—to the Display/Keyboard Processor 35 and to the Duplicate Unit 1a over, by way of example, a Universal Serial Bus 38a or an Infrared Transceiver 38b.

Needless to say, this transfer can be very fast, up to 10 Mbits/second. Accordingly large numbers of tracks of musical works which are stored in MP3 (or related) compressed format on the Hard Drive 30 of one unit may be transferred (i) in gross, (ii) in accordance with a “transfer list” analogous to a “play list”, (iv) as differing in title, or (v) track by track under user control, to the Hard Drive 30 of the other unit. The transfer mode (iv) is especially powerful, permitting a user/operator/owner with a virgin Hard Drive but access to another fully populated CD/ROM and MP3 recorder-player in accordance with the present invention (such as might be owned by a friend) to load large numbers of musical works, typically up to the approximately 1200 that will fit within a 10 Gbit disk storage, to his/her unit in mere minutes.

Additional elements shown in the schematic of FIG. 1 will be substantially self-explanatory to a practitioner of the electronic music system design arts. Power is normally supplied through three separate options: 1) 110-220 volt a.c. input, 2) a battery jack, or 3) batteries. Inputs to the Audio CODEC 33, and associated operational modes, are provided to digitalize (to MP3 format) and record audio information both from a Radio 42a (using an antenna 42b) and a Microphone 43. The Keyboard/Keypad Processor 35 manages the power selection and control, and the operator interface via the Keypad 37 and the Dot Matrix Display Module 36. An output port for the audio signal is provided through plug jack Line Out 39.

2. A First Automatic Defragmentation Method

A flow chart of a preferred embodiment of a first automatic defragmentation method in accordance with the present invention is shown in FIG. 2. In this method both the files and “free space” of the disk are fragmented, and the defragmentation procedure performed serves to defragment both. Namely, the files are made to be contiguous upon the disk one file following another, normally commencing at the beginning of the disk, while the free space remaining, ex of the files, upon the disk is located as one contiguous area, normally at the end of the disk.

In the preferred first method shown in the flow chart of FIG. 2, the controller (i.e., control logics) of that digital recorder/player which incorporates as (one of its) storage media a hard disk is in a master “idle” control loop 201, which condition is always assumed when the recorder/player is “on” (i.e., energized) and is not presently tasked to play, or to record, or to convert in format, digital files, normally digital music.

In decision box 202 the question is asked as to whether or not the recorder/player is idle, meaning devoid of playing or recording or converting tasks. The most common answer to this question is “no”, making entrance into block 206 to process any normal recorder/player operations is made via path 203. At the conclusion of each such operation, the decision block 202 is re-entered via path 205.

When in decision block 202 the question as to whether or not the recorder/player is idle is answered “yes”, then another, second, decision block 204 is entered via path 207. If the question “does the hard disk drive (HDD) need defragmentation” asked in this block is answered “no”, then block 206 is entered as before.

If, however, the HDD is determined in decision block 204 to need defragmentation, then a linear path through blocks 208, 210, 212, 214 and 216 is entered. The decision may be so answered “yes” based on any one or ones of criteria including (1) seeks (repositionings of the disk read head) in the retrieval of a single record (as such record may further be qualified by length or by time) (which record is most commonly a single digital musical work) having exceeded a certain threshold, (2) any “breaks” having exceeding a certain threshold time in the flow of data (most typically representing audio data) in a previous read of a record (normally a song “track”), and/or, most commonly and in full accordance with that particular preferred method that is flow-charted in FIG. 2, (3) running to the end of a que of disk space because all files were contiguously written at the then-existing “end” of the when first recorded, and must now be compacted. (This compaction is of course possible only when some recorded files have since been deleted.)

The sequence of defragmentation in blocks 208, 210, 212, 214 and 216 is entered. Power levels are first checked in block 208 to ensure defragmentation can be accomplished without power loss. An audible or visual alert (or both) may optionally be sent to the user indicating that automatic defragmentation is required and will start in a variable preset amount of time unless disabled by the user. Upon automatic start-up or user manual initiation of defragmentation, all operational functions of the non-computer hard disk drive device will normally be locked out, and disabled, for the duration of the defragmentation operation.

The recorded sectors of the hard disk drive are analyzed by the auto-defragmentation program in blocks 210 and 212. This well-know function is, for the instance of a portable digital device, commonly implemented in firmware. Defragmentation of the hard disk drive then occurs in blocks 214 and 216. The file allocation tables (FATs) and file structures while realigning the segments and clusters to eliminate fragmentation of the files.

After completion of the auto-defrag function, a reanalysis of the hard disk drive preferably occurs automatically as shown in the path 205 leading back to decision blocks 202 and 204. Defragmentation may even be performed iteratively, but, unless a user has steadfastly resisted automatic defragmentation while proceeding to fragment his or her disk drive, need not normally be so performed.

Status is preferably displayed to the user as either “complete” or “finished” or the like and, preferably, the newly-adjusted free space capacity of the hard disk drive—especially if changed because of the defragmentation—may optionally be displayed.

3. A Second Automatic Defragmentation Method

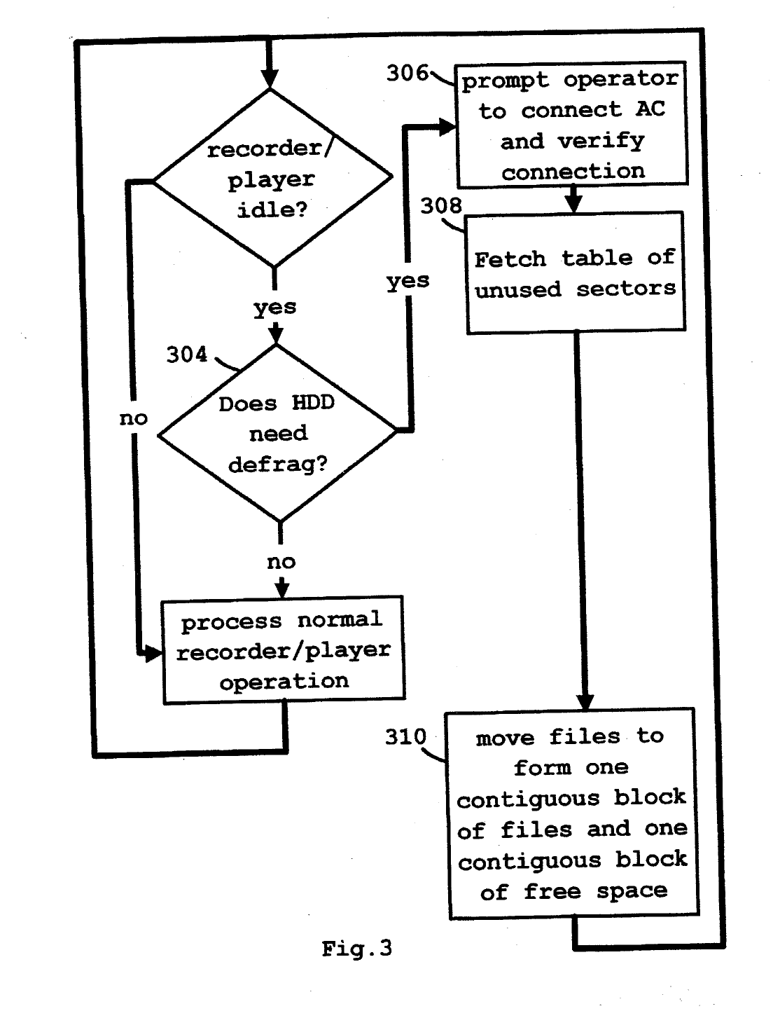

A flow chart of second preferred automatic defragmentation method in accordance with the present invention is shown in FIG. 3.

The crucial block 304 determines the need for defragmentation. If successively recorded files are not written to the “end” of the hard disk drive, as in the method of the previous section 2, then automatic initiation of defragmentation contingent upon reaching the “end” of the recordable area is clearly inappropriate. Nonetheless, those other criteria of the previous section by which a need for defragmentation is determinable are still validly made in block 304. In accordance with the present invention, it is alternatively possible in block 304 to indirectly assess the fragmentation level of a hard disk drive by assessing the read/write performance of the hard disk drive. This assessment depends upon having a general, if not also a specific (derived from the file allocation tables), knowledge of the (i) size and (ii) nature of the files that are stored in the digital device, and the (iii) normal manner of their use. This type of assessment is thus not suitable to a computer, where files of many different lengths, types and uses are stored on the computer's hard disk drive. It is, however, generally suitably applied to assess the substantially linear writing and reading, mostly at a substantially even data transfer rate, of substantially even-length (generally within a multiplier factor of, most commonly, ×4), files of digital music.

As a still further alternative, or complimentary, evaluation performed in block 304, a (micro)program that causes the reading of digital data from the disk can, by reference to a watchdog timer or the like, or to an interrupt attendant upon a buffer underflow of the like, that there has been an interruption in the retrieval of the digital data, and in the playing of what is presumed to be music. Occurrence of but one, or some few, times are not normally determinative of a requirement for defragmentation of the hard disk. However, an up-down “pseudo fault” counter may be kept, and/or like programming techniques employed, to determine both (i) whether things are changing (i.e., getting worse) over time, and/or (ii) whether defragmentation—which may be at times and from time to time user initiated—has any affect on the occurrence of apparent “faults”.

If (i) the user seems to like to manually initiate defragmentation of the hard disk drive—putatively for cause—and (ii) some change of some moment can be detected in the “fault” counter, then the firmware program can act to thereafter alert the user to a detected accrual, or escalation, in detected “faults”, and ask the user to approve an automatic defragmentation of files.

This might be called “adaptive defragmentation”; namely, defragmentation proportional to both (1) the files written, stored and read, and (2) the uses to which they are put—regardless of what are the files or the uses. This is a very powerful technique. For example, consider the battlefield of the future where a combatant may assimilate data upon the hard drive of his (or her) “wearable” computer. Some specialized combatants may shoot (and ultimately transmit) digital video records of battle, battlegrounds, tactical dispositions and situations and the like, which digital video records will generally be quite voluminous. Other specialized combatants may be probing the environment, monitoring machines, and accumulating and reporting digital status records in batches at times and from time to time. These digital status records are generally short.

Clearly the hard drives of both combatants will, ultimately, require defragmentation. Once the concepts of the present invention are assimilated, programmers or advanced skills are expected to be able to think just as clearly about strategies and practice for the maintaining the combat system disk drive as, for example, accumulating and using power from the power pack of the combat system.

The block 306 of FIG. 3 is analogous, and performs the like function, to block 206 of FIG. 2. The fetching of the unused sectors in block 308, and the relocation of files in block 308, realize a simple, and “brute force”, form of defragmentation.

4. A Less Preferred Method of Defragmentation Drawing Attention to the Present Invention as Primarily any Form of Defragmentation Automatically Performed Predicated on Fragmented Conditions Sensed, and not as any Particular Algorithm for or Process of Defragmentation

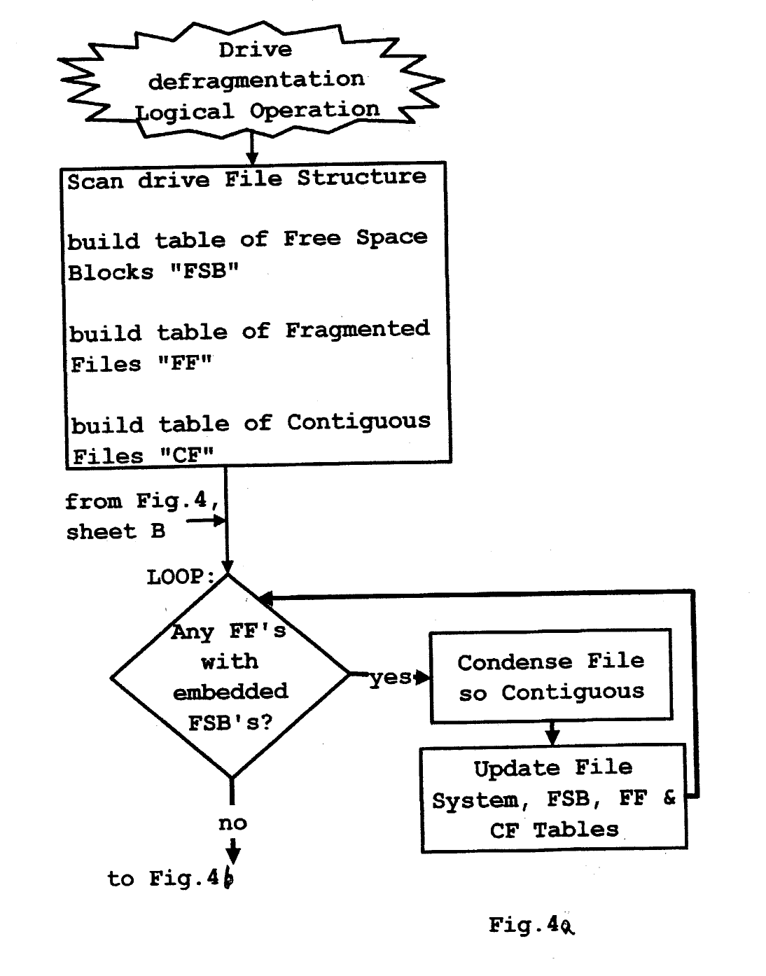

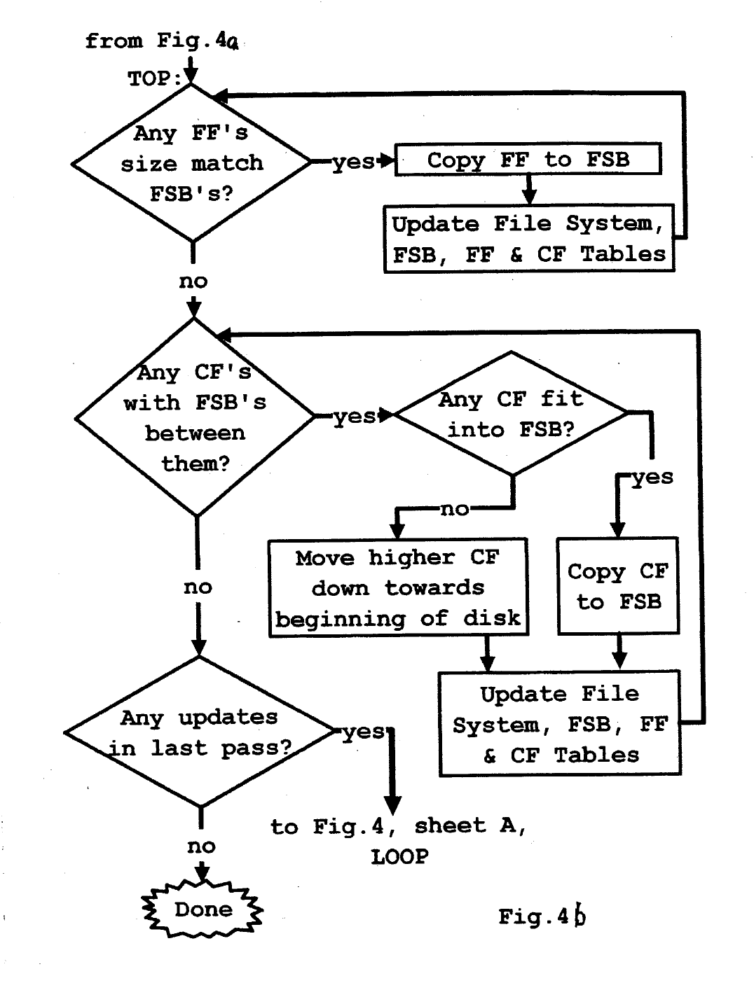

A flow chart of a less preferred embodiment of only a defragmentation operation as may be performed as part of the automatic defragmentation of the present invention is shown in FIG. 4. In so showing only the process of defragmentation, and not how it might be entered into in an automated fashion, the flow chart of FIG. 4 corresponds to the right column only of FIGS. 2 and 3.

FIG. 4 is included in this specification not simply as an alternative method of defragmentation—of which there are many in the prior programming arts and of which the particular method of FIG. 4 is not particularly elegant—but in order to draw attention to the present invention as primarily any form of defragmentation automatically performed predicated on fragmented conditions sensed, and not as any particular algorithm for or process of defragmentation. In simplest terms, the forte of the present invention is not simply that defragmentation may be performed, or that it may preferably be so performed by new methods that are particularly well suited to a hard disk used for the substantially linear writing and reading at substantially even demand rates of substantially even-length (generally within a multiplier factor of, most commonly, ×4) files of digital music. Instead, the forte of the present invention—to which the preferred methods are admittedly contributory, integrated, and effective—is to recognize that, and when, defragmentation should be performed in the first place.

Therefore, by showing yet another substitute (substantially) for the right column of FIGS. 2 and 3, FIG. 4 actually serves to emphasize the block “Does HDD need defrag?” in both FIGS. 2 and 3. As explained in the Background of the Invention section of this specification, this question (i) is not be asked, (ii) is being asked too seldom, and/or (iii) is being asked inappropriately, and without consideration of those factors taught herein that properly make that a disk—especially as is used in recording (writing), storing and playing (reading) digital music—needs defragmentation.

In interpretation of FIG. 4, the “File Size” is the number of sectors, clusters, or other storage units needed to hold the data. “Contiguous” means that the file data is in one or more continuous sequential block(s) upon the hard disk drive. “Condense” means to move file data until it is contiguous. “Size Match” means that the size of each of arbitrary files under evaluation is related to the “Free Space Block” (“FSB”) size presently being filled, using a best fit algorithm.

Assumptions in the operation of the defragmentation of FIG. 4 are that minimal CPU memory is available (or at least used). The files are not buffered in RAM, only the file tables. Further, approximately 10% to 15% of the recording area of the hard disk drive is free space, with at least one large open block always being greater than or equal to the largest fragmented file. Finally in the flow-charted method the tables can hold part of the file system information in a sliding window scheme.

These constructs will be well understood by those skilled in the programming arts, as will the defragmentation process of FIG. 4 without further explanation.

In accordance with the preceding explanation, variations and adaptations of the automatic defragmentation method in accordance with the present invention will suggest themselves to a practitioner of the digital computer programming arts.

For example, delays to fragmentation could be monitored by hardware “watchdogs” so as to trigger software processes (of the preferred types taught herein).

In accordance with these and other possible variations and adaptations of the present invention, the scope of the invention should be determined in accordance with the following claims, only, and not solely in accordance with that embodiment within which the invention has been taught.

What is claimed is:

1. A method of managing the recording of data upon a hard disk drive comprising:
writing any and all new files onto the hard disk drive starting at a location which is then, at the time of the writing of each file, at the beginning of a commodious open and terminal area of the hard disk called the “free space” of the hard disk, one file following the next in sequence as and when each file is written until, the free space of the disk becoming filled to a predetermined extent,
simplified-defragmenting ensues, the simplified-defragmenting simply moving each file upon the hard disk towards the beginning of the hard disk, and into tight-packed proximity with a neighboring earlier file, as is possible, the simplified-defragmenting making that earlier unerased unmodified recorded files upon the hard disk become tightly packed together while, to such extent as the tight packing of files opens up space upon the disk, the free space of the disk is reconstituted in whole or in part;
wherein if a specified file in the tight-packed area of the disk is erased, or modified, then neither it nor any other and newly-written file are then written into the hard disk space previously occupied by the specified file, which space is simply cleared, but any modified version of this file will instead be written into the “free space” area of the hard disk;
wherein fragmentation of records is substantially avoided at the cost of having to perform simplified-defragmenting where files not tightly packed are moved into tight-packed positions upon, and from the beginning of, the disk drive.

2. The method according to claim 1 that, when the free space of the disk has become filled to the predetermined extent, further comprises:
alerting a user of the hard disk drive that the simplified-defragmenting will ensue.

3. The method according to claim 2 that, when the free space of the disk has become filled to the predetermined extent and the user alerted, further comprises:
permitting the user to postpone the simplified-defragmenting.

4. The method according to claim 1
wherein recording of new files upon the hard disk drive is prohibited during duration of the simplified-defragmenting.

5. An automatic defragmentation method for a hard disk drive comprising:
recognizing during normal use of the hard disk drive, and without any manual or any scheduled invocation of any fragmentation assessment routine, when files of a hard disk drive are undesirably fragmented; and, responsively to the recognizing,
defragmenting the files of the hard disk drive until they are at least temporarily no longer recognized as undesirably fragmented.

6. The hard disk drive automatic defragmentation method according to claim 5 wherein the recognizing comprises:
directly reading the files stored upon the hard drive; and
assessing the extent of their fragmentation.

7. The hard disk drive automatic defragmentation method according to claim 6 wherein the assessing of the extent of the fragmentation of files is relative to a level preset for the hard disk drive upon manufacture of any device in which the hard disk drive is contained.

8. The hard disk drive automatic defragmentation method according to claim 6 wherein the assessing of the extent of the fragmentation of files is relative to a level set for the hard disk drive by a user of a device in which the hard disk drive is contained.

9. The hard disk drive automatic defragmentation method according to claim 5 wherein the recognizing comprises:
indirectly assessing read/write performance of the hard drive so as to impute the fragmentation condition of the files.

10. The hard disk drive automatic defragmentation method according to claim 5 wherein the defragmenting comprises:
first checking power levels of a device in which the hard disk drive is contained to ensure defragmentation of files can be accomplished without exhaustion of power.

11. The hard disk drive automatic defragmentation method according to claim 5 wherein the defragmenting comprises:
making an alert to the user of a device in which the hard disk drive is contained, the alert stating both that automatic defragmentation is required and will start in a variable preset amount of time.

12. The hard disk drive automatic defragmentation method according to claim 11 wherein the defragmenting further comprises:
permitting the user to postpone defragmenting if he/she chooses not to proceed.

13. The hard disk drive automatic defragmentation method according to claim 5 wherein normal operational functions using the hard disk drive are disabled in a device in which the hard disk drive is installed for the duration of the defragmenting.
